(19) United States
(12) Patent Application Publication
(10) Pub. No.: US 2001/0050710 A1
(43) Pub. Date: Dec. 13, 2001

(54) AUDIO SENSING, DIRECTIONALLY POSITIONING VIDEO CONFERENCE CAMERA

(75) Inventors: DAVID G. ELLIS, HILLSBORO, OR (US); LOUIS J. JOHNSON, ALOHA, OR (US); BALAJI R. PARTHASARATHY, FT. COLLINS, CO (US); PETER B. BLOCH, PORTLAND, OR (US); STEVEN R. FORDYCE, SALEM, OR (US); BILL A. MUNSON, PORTLAND, OR (US)

Correspondence Address: STEVEN P. SKABRAT, BLAKELY SOKOLOFF TAYLOR & ZAFMAN, SEVENTH FLOOR, 12400 WILSHIRE BOULEVARD, LOS ANGELES, CA, 90025

(73) Assignee: MARK J. FINK

(21) Appl. No.: 09/004,051

(22) Filed: Jan. 7, 1998

(51) Int. Cl. H04N 7/14

(52) U.S. Cl. 348/211; 348/14.08

(57) ABSTRACT

An audio sensitive video conferencing camera is disclosed. The video conferencing camera includes a servo mechanism that operates to directionally position the video conferencing camera, and a processor that operates to control the servo mechanism to directionally position the video conferencing camera responsive to audio sensed.

### BACKGROUND OF THE INVENTION

1. Field of the Invention

The present invention relates to the field of video conferencing. More specifically, the present invention relates to video cameras employed in video conferencing.

2. Background Information

As advances in microprocessor and other related technologies continue to improve the price/performance of various electronic components, video conferencing, including video conferencing conducted using personal computers, has become increasingly popular in recent years. Numerous video conferencing products are now available in the market place. An example of such video conferencing products is the ProShare™ Video Conferencing product, available from Intel Corp., of Santa Clara, Calif., the assignee of the present invention, which is designed to take advantage of the increasing processing power of today's personal computers.

Conventional video conferencing cameras suffer from a number of disadvantages. One of which is the marginal or total lack of support for multiple speakers at one end point of a video conference. In the case of historic video conferencing products, typically at best the video conferencing camera can be zoomed out to include all conference participants at the end point. This often leads to less satisfying user experience, as in many conferences, a small percentage of the multiple participants speak most of the time while the rest of the multiple participants occasionally participate. As a result, the users are left with the undesirable choices of either over including or under including the number of participants in the video pictures, or having to fuss around with manual zooming in and out during the video conference. In the case of personal computer video conferencing products, as they were originally designed for single participant at each end point, typically there are no support at all to accommodate multiple participants at one end point Thus, a more user friendly video conferencing camera designed to support multiple participants at one end point is desired.

### SUMMARY OF THE INVENTION

An audio sensitive video conferencing camera is disclosed. The video conferencing camera includes a servo mechanism that operates to directionally position the video conferencing camera, and a processor that operates to control the servo mechanism to directionally position the video conferencing camera responsive to audio sensed.

In one embodiment, the processor controls the servo mechanism to position the video conferencing camera in a direction of a current speaker, based on the difference in the strengths of the audio sensed for the different speakers, while operating in a multi-participant mode. The difference in the strengths of the audio sensed is analyzed using actual audio signals of the speech uttered by the speakers. A switch mechanism is provided to place the video conferencing camera in the multi-participant mode.

### BRIEF DESCRIPTION OF DRAWINGS

The present invention will be described by way of exemplary embodiments, but not limitations, illustrated in the accompanying drawings in which like references denote similar elements, and in which:

FIG. 1 is a perspective view of one embodiment of a video conferencing system incorporated with the audio sensitive video conferencing camera of the present invention;

FIG. 2 is an architectural view of the audio sensitive video conferencing camera of FIG. 1; and

FIGS. 3a-3c are block diagrams illustrating one embodiment of the operational flow of the control logic provided to the processor of FIG. 2.

### DETAILED DESCRIPTION OF THE INVENTION

In the following description, various aspects of the present invention will be described. Those skilled in the art will also appreciate that the present invention may be practiced with only some or all aspects of the present invention. For purposes of explanation, specific numbers, materials and configurations are set forth in order to provide a thorough understanding of the present invention. However, it will also be apparent to one skilled in the art that the present invention may be practiced without the specific details. In other instances, well known features are omitted or simplified in order not to obscure the present invention.

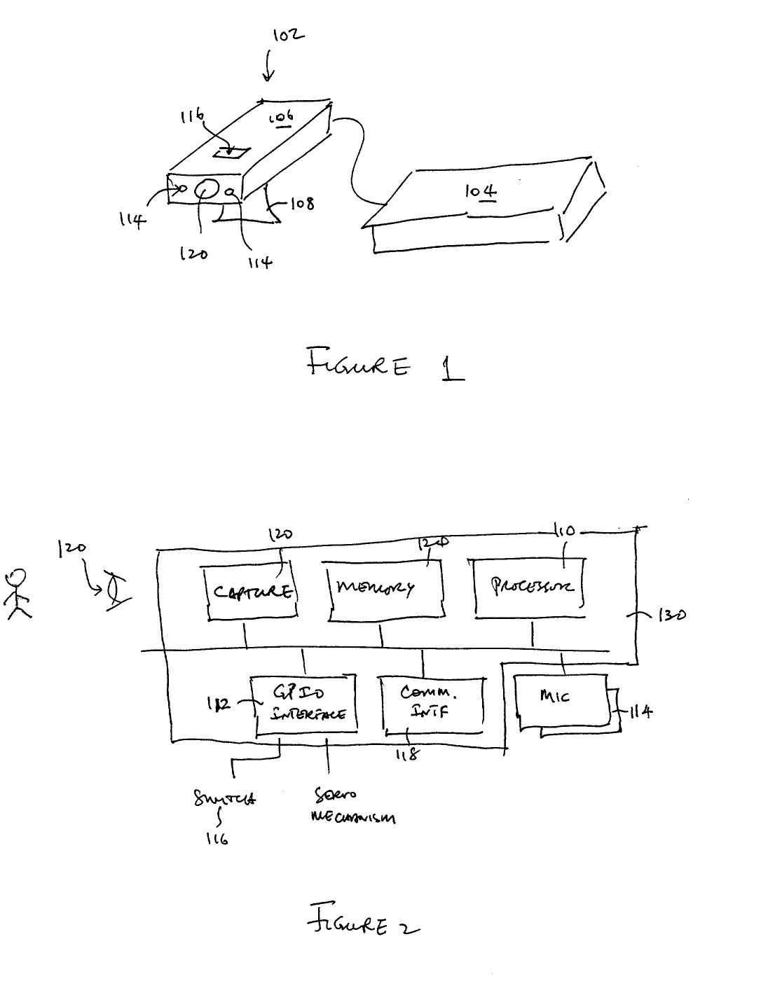

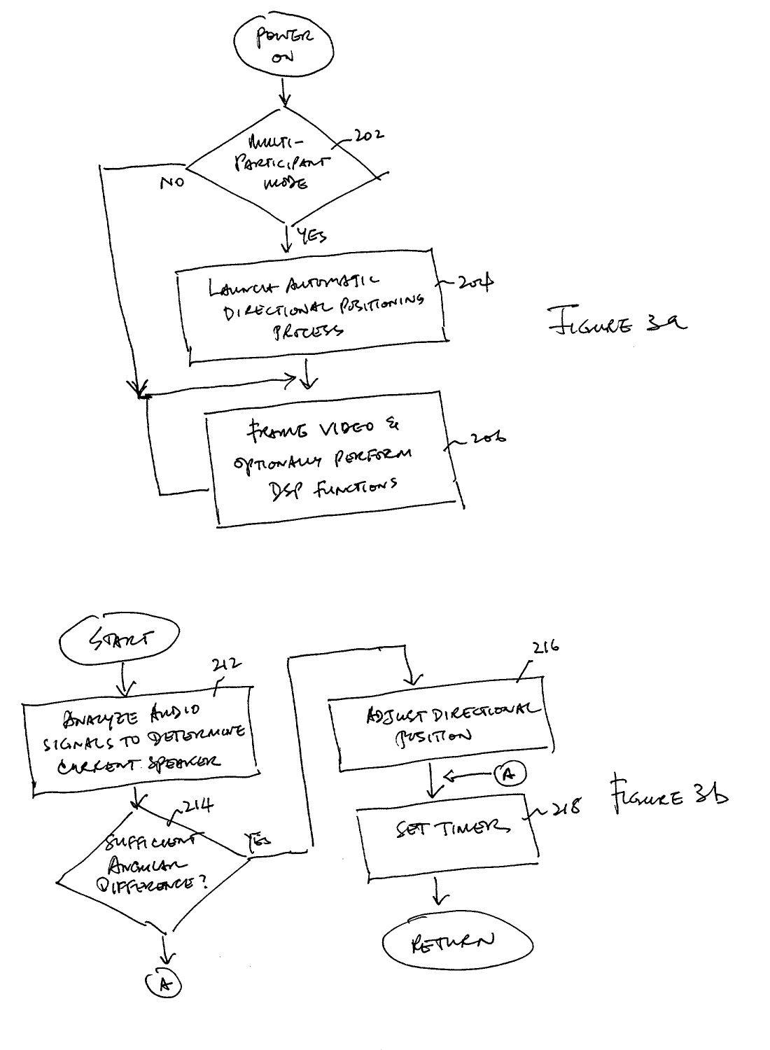

Referring now to FIGS. 1-2, wherein a perspective view of one embodiment of a video conferencing system incorporated with the audio sensitive video conferencing camera of the present invention, and an architectural view of one embodiment of the video conferencing camera of the present invention are shown. Video conferencing system 100 of the present invention includes audio sensitive video conferencing camera 102 of the present invention (hereinafter simply video camera), and system unit 104. Video camera 102 generates video signals for use by system unit 104 in a video conference with other end points. In accordance with the present invention, video camera 102 generates the video signal from a directional position of a current speaker, making video camera 102 particularly suitable for video conferences involving multiple participants at an end point.

For the illustrated embodiment, video camera 102 includes main body 106 and base unit 108 mechanically engaged with each other in a manner that allows main body 106 to swivel over base unit 108. Housed inside base unit 108 in particular is a servo mechanism (not visible) that operates to control the swiveling, i.e. the directional positioning of video camera 102. The servo mechanism directionally positions video camera 102 under the control of processor 110, which for the illustrated embodiment, is housed inside main body 106. As shown in FIG. 2, processor 110 controls the servo mechanism through general purpose input/output (GPIO) interface 112. The mechanical engagement, the servo mechanism, as well as GPIO interface 112 may be implemented using any one of a number of these mechanisms/elements known in the art.

Processor 102 determines the direction of the current speaker based the difference in strengths of the audio sensed for the different speakers. For the illustrated embodiment, processor 102 determines the direction of the current speaker based the difference in strengths of the audio signals output by a pair of microphones 114 integrated with video camera 102, more specifically, disposed on the front surface of main body 106. In an alternate embodiment, processor 102 may determine the direction of the current speaker based on audio sensing signals output by audio sensors that are merely indicative of audio sensed, as oppose to the actual audio signals induced by the speech uttered by the speakers. Either way, microphones 114 as well as the alternative basic audio sensors may be disposed away from video camera 102, e.g. on system unit 104.

In one embodiment, processor 110 maintains a number of measures to prevent excessive movement of video camera 102. One of the measures employed is a minimum duration at any directional position for video camera 102. In other words, processor 110 will not reposition video camera 102 unless it has stayed at the current directional position beyond the minimum duration. Another measure employed is a relatively liberal angular tolerance level for video camera 102. In other words, processor 110 will not reposition video camera 102 unless the directional position of the current speaker is more than a predetermined angular measure away from the current directional position of video camera 102.

For the illustrated embodiment, processor 110 directionally positions video camera 102 while operating in a multi-participant mode. While not operating in the multi-participant mode, processor 110 operates video camera 102 in a single participant mode, where directional positioning of video camera 102 in accordance with audio sensed is disabled. The multi-participant mode and the converse single participant mode are set by way of switch 116 integrated with video camera 102. The state of switch 116 is communicated to processor 110 through GPIO interface 112. Processor 110 is interrupted whenever switch 116 changes its state. Alternatively, separate I/O interface may be employed. Furthermore, processor 110 may be instructed to operate video camera 102 in either the multi-participant mode or the single participant mode by system unit 104 through e.g. communication interface 118, responsive to user inputs through e.g. a graphical user interface.

In addition to processor 110, GPIO interface 112 and microphones 114, video camera 102 further includes lens 120, capture 122, memory 124, and bus 126 coupled to each other as shown. Capture 122 performs the conventional function of generating video signals responsive to lights reflected off objects within the field of sight of lens 120 and passes through lens 120. The “raw” video data are placed in memory 124. Processor 110 frames the video data and provides them to system unit 104 through communication interface 118. Processor 110 may also perform any number of additional signal processing functions, including but not limited to e.g. gain, luminance, and/or chrominance adjustment, as well as video data compression. These elements, i.e. processor 110, capture 122, memory 124 and so forth, are disposed on printed circuit board 130, which is housed in main body 106.

Similar to GPIO interface 112, these elements, i.e. processor 110, capture 122, memory 124 and so forth, are all intended to represent a broad category of these elements known in the art. In particular, processor 110 is intended to represent 8-bit or more microcontrollers (MCU), 16-bit or more digital signal processors (DSP), as well as 32-bit or more general purpose microprocessors (MP). Except for high end models with very high capacity and additional controls, it is expected that an inexpensive 8-bit MCU will suffice. In the case of communication interface 118, it may be a parallel port, a universal serial bus port, an IEEE 1394 compatible port or other like I/O interfaces. Universal serial bus is described in the Universal Serial Bus Specification, Revision 1.0, Jan. 16, 1996, available from Intel Corp., of Santa Clara, Calif., and IEEE 1394 is described in the High Performance Serial Bus specification, IEEE Standard 1394, draft 8.0v3, approved Dec. 12, 1995, available from IEEE.

System unit 104 is intended to represent a number of video conferencing system units known in the art, including but not limited to e.g. personal computers equipped with the Pentium® II processors, available from Intel Corp., and the above described ProShare™ video conferencing product.

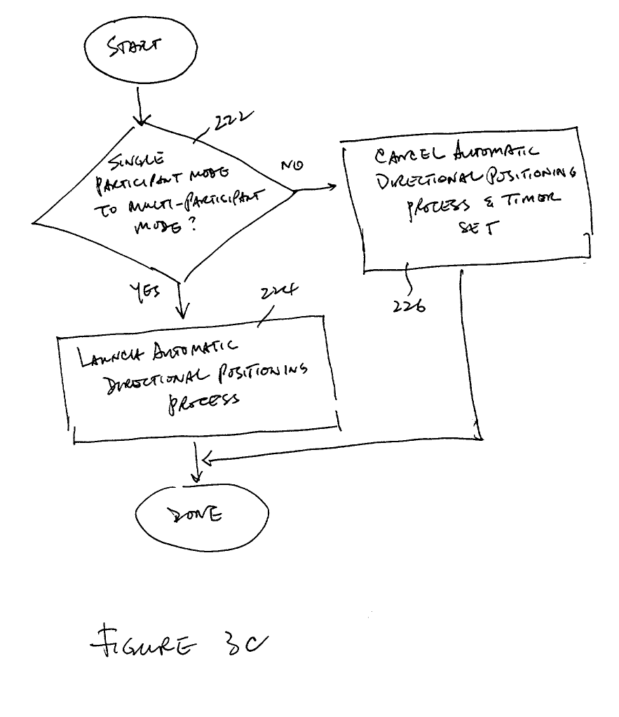

FIGS. 3a-3c illustrate one embodiment of the operational flow of the control logic provided to processor 110. As shown in FIG. 3a, upon power on, at step 202, processor 110 determines whether it is to operate video camera 102 in the single or multiple participant mode; for the illustrated embodiment, in accordance with the state of switch 116. If processor 110 is to operate video camera 102 in the multi-participant mode, it launches an automatic directional positioning process, step 204, prior to proceeding to step 206 and performs its conventional video data framing and other applicable signal processing functions. If processor 110 is to operate video camera 102 in the single participant mode, it skips step 204 and proceeds to step 206 directly. In any case, upon entering step 206, processor 110 remains there, until processor 110 is interrupted or video camera 102 is powered off. Upon servicing an interrupt, processor 110 again continues at step 206, until another interrupt or finally, video camera 102 is powered off.

FIG. 3b illustrates one embodiment of the operational step of the automatic directional positioning process. As shown, upon given control, at step 212, the audio signals are analyzed to determine the direction of the current speaker. The analysis may be performed in a number of known ways, from simple amplitude comparison, to complex audio characteristic analysis. Once determined, at step 214, the angular difference between the current directional position and the current speaker's directional position is determined. If the angular difference is greater than the predetermined threshold, adjustment to the directional position of video camera 102 is made, step 216, otherwise the step is skipped. Regardless whether the directional position of video camera 102 is adjusted, at step 218, a timer is set for the next point in time (at the expiration of the timer) where the directional position of video camera 102 is to be checked. Upon setting the timer, control is returned to the main process, i.e. step 206 of FIG. 3a.

FIG. 3c illustrates one embodiment of the operational flow of an interrupt handler for handling the interrupt triggered by the state change of switch 116. At step 222, it is determined whether switch 116 has changed from the single participant mode to the multi-participant mode, or whether switch 116 has changed from the multi-participant mode to the single participant mode. In the first case, the automatic directional positioning process is launched as described earlier, step 224, whereas in the later case, the automatic directional positioning process is cancelled, including the timer setting, step 226.

In general, those skilled in the art will recognize that the present invention is not limited by the details described; instead, the present invention can be practiced with modifications and alterations within the spirit and scope of the appended claims. The description is thus to be regarded as illustrative instead of restrictive on the present invention.

Thus, an audio sensitive video conferencing camera has been described.

What is claimed is:

1. A video conferencing camera comprising:
(a) a servo mechanism that operates to aim the video conferencing camera at a selected one of a plurality of directional positions; and
(b) a processor coupled to servo mechanism that operates to control the servo mechanism to directionally position the video conferencing camera responsive to audio sensed.

2. The video conferencing camera as set forth in claim 1, wherein the processor controls the servo mechanism to directionally position the video conferencing camera towards a direction of a current speaker, determined in accordance with said audio sensed.

3. The video conferencing camera as set forth in claim 2, wherein the processor determines the direction of the current speaker based on the difference in strengths of the audio sensed for the different speakers.

4. The video conferencing camera as set forth in claim 3, wherein the processor receives a plurality of audio sensing signals indicative of audio sensed, and uses the received audio sensing signals to determine to direction of the current speaker.

5. The video conferencing camera as set forth in claim 4, wherein the plurality of audio sensing signals are provided by audio sensors external to the video conferencing camera.

6. The video conferencing camera as set forth in claim 4, wherein the plurality of audio sensing signals are provided by audio sensors integrated with the video conferencing camera.

7. The video conferencing camera as set forth in claim 3, wherein the processor receives a plurality of audio signals representative of the audio sensed, and uses the received audio signals to determine to direction of the current speaker.

8. The video conferencing camera as set forth in claim 7, wherein the video conferencing camera further includes a plurality of microphones that operate to generate the audio signals.

9. The video conferencing camera as set forth in claim 1, wherein the processor is housed in a main body, and the servo mechanism is housed in a base unit mechanically engaged with the main body.

10. The video conferencing camera as set forth in claim 1, wherein the processor directionally positions the video conferencing camera in accordance with audio sensed, while the video conferencing camera operates in a multi-participant mode.

11. The video conferencing camera as set forth in claim 10, wherein the video conferencing camera further includes a switch mechanism coupled to the processor to allow a user to place the video conferencing camera into the multi-participant mode.

12. The video conferencing camera as set forth in claim 10, wherein the processor operates the video conferencing camera in the multi-participant mode responsive to instructions received from a host video conferencing system.

13. The video conferencing camera as set forth in claim 1, wherein the video conferencing camera further includes a communication interface, and the processor being also coupled to the communication interface further operates to provide the video signals to a host video conferencing system through the communication interface.

14. The video conferencing camera as set forth in claim 13, wherein the communication interface is one of a parallel port, a universal serial bus port, and an IEEE 1394 compatible port.

15. The video conferencing camera as set forth in claim 1, wherein the processor is one of a 8-bit or more microcontroller, a 16-bit or more digital signal processor and a 32-bit or more general purpose microprocessor.

16. A video conferencing system comprising
(a) a video camera having a servo mechanism that operates to aim the video conferencing camera at a selected one of a plurality of directional positions, and a processor coupled to servo mechanism that operates to control the servo mechanism to directionally position the video camera responsive to audio sensed; and
(b) a system unit coupled to the video camera that utilizes the video signals in a video conference.

17. The video conferencing system as set forth in claim 16, wherein the processor of the video camera controls the servo mechanism of the video camera to directionally position the video camera towards a direction of a current speaker, determined in accordance with said audio sensed.

18. The video conferencing system as set forth in claim 17, wherein the processor of the video camera determines the direction of the current speaker based on the difference in strengths of the audio sensed for the different speakers.

19. The video conferencing system as set forth in claim 18, wherein the processor of the video camera receives a plurality of audio sensing signals indicative of audio sensed, and uses the received audio sensing signals to determine to direction of the current speaker.

20. The video conferencing system as set forth in claim 19, wherein the plurality of audio sensing signals are provided by audio sensors external to the video camera.

21. The video conferencing system as set forth in claim 19, wherein the plurality of audio sensing signals are provided by audio sensors integrated with the video camera.

22. The video conferencing system as set forth in claim 18, wherein the processor of the video camera receives a plurality of audio signals representative of the audio sensed, and uses the received audio signals to determine to direction of the current speaker.

23. The video conferencing system as set forth in claim 22, wherein the video camera further includes a plurality of microphones that operate to generate the audio signals.

24. The video conferencing system as set forth in claim 16, wherein the processor of the video camera is housed in a main body of the video camera, and the servo mechanism of the video camera is housed in a base unit of the video camera mechanically engaged with the main body of the video camera.

25. The video conferencing system as set forth in claim 16, wherein the processor of the video camera directionally positions the video camera in accordance with audio sensed, while the video camera operates in a multi-participant mode.

26. The video conferencing system as set forth in claim 25, wherein the video camera further includes a switch mechanism coupled to the processor of the video camera to allow a user to place the video camera into the multi-participant mode.

27. The video conferencing system as set forth in claim 25, wherein the processor of the video camera operates the video camera in the multi-participant mode responsive to instructions received from a host video conferencing system.

28. The video conferencing system as set forth in claim 16, wherein the video camera further includes a communication interface, and the processor of the video camera being also coupled to the communication interface of the video camera further operates to provide the video signals to a host video conferencing system through the communication interface of the video camera.

29. The video conferencing system as set forth in claim 28, wherein the communication interface of the video camera is one of a parallel port, a universal serial bus port, and an IEEE 1394 compatible port.

30. The video conferencing system as set forth in claim 16, wherein the processor of the video camera is one of a 8-bit or more microcontroller, a 16-bit or more digital signal processor and a 32-bit or more general purpose microprocessor.
